(19) United States
(12) Patent Application Publication
(10) Pub. No.: US 2024/0378519 A1
(43) Pub. Date: Nov. 14, 2024

(54) COMPUTER-IMPLEMENTED METHOD AND SYSTEM FOR ASSESSING COMPATIBILITY OF HUMAN RESOURCES WITHIN AN ORGANIZATION

(71) Applicant: Atmanco Inc., Montréal (CA)

(72) Inventors: Marie-Christine Drolet, Montréal (CA); Laurent Barcelo, Saint-Laurent (CA)

(21) Appl. No.: 18/316,020

(22) Filed: May 11, 2023

(51) Int. Cl. G06Q 10/0631

(52) U.S. Cl. CPC G06Q 10/06312

(57) ABSTRACT

A computer-implemented method for assessing compatibility of resources within organizations is disclosed. The method comprises retrieving, from a profile dataset, attribute entries associated with a given resource and a manager, job entries associated with a job profiles, and organization entries associated with the organization; inputting in an AI recommender system the attribute entries, the job entries and the organization entries, generating by the AI recommender system competencies scores of the given resource and the manager, an indication of strengths and challenges of a duo formed by the given resource and the manager, for a given job profile within the organization; and recommendations and action items based on the indication of the strengths and challenges of the duo; and displaying, in a user interface, the competencies scores of the given resource and the manager, the strengths and the challenges of the duo and the recommendations and actions items for the duo.

### TECHNICAL FIELD

The technical field generally relates to human resources management, and more particularly to computer-implemented method and system for automating assessment of compatibility of human resources within an organization.

### BACKGROUND

Every company is interested in maximizing their resources at their best potential and ensure that each resource is assigned to the right team with the right manager.

It may take several hours for a psychologist and/or a human resource manager to evaluate attributes of a resource within a company, evaluate attributes of his/her manager and evaluate the context of the company before being able to assess the compatibility of such resource for a specific job, within the company and/or with his/her manager. This assessment is often time consuming and not always consistent from one psychologist to another.

Once such assessment is done, the psychologist and/or a human resource manager can provide a recommendation and/or an action plan, based on their own knowledge.

However, the psychologist and/or the human resource manager can have cognitive bias, particularly when the psychologist and/or the human resource manager personally know the resource and/or his/her manager.

It would be desirable to provide an improved system and method for assessing compatibility of human resources within an organization, which can be based on more reliable data, and which can produce more robust and consistent recommendations.

### SUMMARY

According to one aspect, there is provided an improved system and method for assessing compatibility of human resources within an organization that satisfies at least one of the above-mentioned needs.

According to one aspect, there is provided a computer-implemented method for assessing compatibility of resources within organizations, the method comprising retrieving, from a profile dataset, attribute entries associated with a given resource and a manager, job entries associated with one or more job profiles, and organization entries associated with the organization; inputting in an AI recommender system the attribute entries, the job entries and the organization entries, generating by the AI recommender system: competencies scores of the given resource and the manager; an indication of strengths and challenges of a duo formed by the given resource and the manager, for a given job profile within the organization; and recommendations and action items based on the indication of the strengths and challenges of the duo; and displaying, in a user interface, the competencies scores of the given resource and the manager, the strengths and the challenges of the duo and the recommendations and actions items for the duo.

In at least one embodiment, the method further comprises the steps of generating by the AI recommender system: adjusted competencies scores of the given resource based on the given job profile within the organization and based on a context and company culture; and recommendations and action items based on the adjusted competencies scores; and displaying, in the user interface, the strengths and the challenges of the resource based on the adjusted competencies scores and the recommendations and actions items for the resource based on the given job profile and the given context and company culture.

In at least one embodiment, the AI recommender system is configured based on static rules derived from scientific studies.

In at least one embodiment, the AI recommender system comprises one or more machine learning models.

In at least one embodiment, the method further comprises the steps of training the one or more machine learning models using a combination of a synthetic dataset and a field dataset; the attribute entries, the job profile entries and the organization entries being inputted in the trained machine learning models, and the trained machine learning models predicting: the competencies of the resource, the competencies of the manager, the indication of the strengths and challenges of any given duo of resource-manager and the recommendations and action items for said given duo.

In at least one embodiment, the method further comprises the step of generating the synthetic dataset based on a plurality of artificially created duos of individuals linked to random job profiles and random organizations, the artificially created duos being defined by specific attributes parameters and being attributed specific competencies, specific strengths and challenges and specific recommendations and actions items obtained from deterministic rules.

In at least one embodiment, the one or more machine learning models are initially trained using only the synthetic dataset.

In at least one embodiment, the method further comprises the steps of receiving, from the user interface, a selection of a subset of the recommendations and actions items; and repeating the previous steps for a plurality of organizations and for a plurality of duos of resources and managers, to create and update a field dataset based on an association of the inputted entries with the generated strengths and challenges, and with the subsets of recommendations and actions items selected for each duo; and iteratively modifying the AI recommender system using the field dataset that is gradually built through repeated use of the AI recommender system, to reflect the selections made in the user interface.

In at least one embodiment, a ratio of the field dataset over the synthetic dataset is adjustable.

In at least one embodiment, an assessment of relevancy of the recommendations and action items is also captured from the user interface, the assessment being used in generating and/or updating the field dataset.

In at least one embodiment, the recommendations and actions items for the duo, displayed in the user interface comprises recommendations directed to the resource; recommendations directed to the manager; action items directed to the resource; and/or action items directed to the manager.

In at least one embodiment, a portion of the recommendations and actions items for the duo, displayed in the user interface comprises a priority tag.

In at least one embodiment, the selection comprises at least one of a prioritization, a selection, a completeness check of the recommendations and/or of the action items.

In at least one embodiment, attributes entries associated with a given resource comprises parameters obtained from at least one of: a psychometric evaluation, a cognitive ability test, a personality test, an organizational preferences test; and a learning mode test.

In at least one embodiment, attributes entries associated with a manager comprises parameters obtained from at least one of: a psychometric evaluation, a personality test, and a learning mode test.

In at least one embodiment, predicting the indication of the strengths and challenges of the duo further comprises predicting: a dominant personality style and a secondary personality style of the resource and the manager; and preferences and values for the resource.

In at least one embodiment, the AI recommender system is accessible by at least one application programming interface (API).

According to another aspect, there is provided a system implementing a virtual coach platform for assessing compatibility of resources within an organization, the system comprising one or more processors; a user interface that obtains attributes entries associated with a given resource and a manager, job entries associated with one or more job profiles, and organization entries associated with the organization; wherein the attribute entries, the job entries, and the organization entries are stored in a profile dataset; a memory storing instructions that, when executed by the one or more processors, cause the system to perform operations comprising: retrieving, from a given profile dataset of the memory, attributes entries associated with a given resource and a manager, job entries associated with one or more job profiles, and organization entries associated with the organization; inputting in an AI recommender system the attributes entries, the job profile entries and the organization entries, generating by the AI recommender system: competencies scores of the given resource and the manager; an indication of strengths and challenges of a duo formed by the given resource and the manager, for a given job profile within the organization; and recommendations and action items based on the indication of the strengths and challenges of the duo; and displaying, in a user interface, the competencies scores of the given resource and the manager, the strengths and the challenges of the duo and the recommendations and actions items for the duo.

According to another aspect, there is provided a non-transitory computer-readable storage medium storing instructions that, when executed by a computing system having one or more processors, cause the computing system to perform operations for assessing compatibility of resources within an organization, the operations comprising: retrieving, from a given profile dataset, attributes entries associated with a given resource and a manager, job entries associated with one or more job profiles, and organization entries associated with the organization; inputting in an AI recommender system the attributes entries, the job profile entries and the organization entries, generating by the AI recommender system: competencies scores of the given resource and the manager; an indication of strengths and challenges of a duo formed by the given resource and the manager, for a given job profile within the organization; and recommendations and action items based on the indication of the strengths and challenges of the duo; and displaying, in a user interface, the competencies scores of the given resource and the manager, the strengths and the challenges of the duo and the recommendations and actions items for the duo.

### BRIEF DESCRIPTION OF THE DRAWINGS

FIG. 1 is a block diagram illustrating a method and a system of a virtual coach platform for automating assessment compatibility of resources within an organization, in one embodiment.

FIG. 2 is a block diagram illustrating relationship between assessment test and attributes entries, in an embodiment.

FIG. 3 is a diagram illustrating example user interface showing results of general cognitive ability and personality traits of a resource, in one embodiment.

FIG. 4 is a block diagram illustrating an overview of an environment in which some implementations can operate, in an embodiment.

FIG. 5 is a block diagram illustrating relationship between attributes entries and multisource status, in an embodiment.

FIG. 6 is an exemplary table of expert rules for the personality traits scores, in an embodiment.

FIG. 7 is a diagram illustrating example user interface showing results of resource competencies, in one embodiment.

FIG. 8 is a diagram illustrating example user interface showing results of resource competencies with warnings, in one embodiment.

FIG. 9 is a diagram illustrating example user interface showing results of a resource personality profile, in one embodiment.

FIG. 10 is an exemplary table of expert rules to determine a personality style based on personality traits, in an embodiment.

FIGS. 11 and 12 are exemplary tables of expert rules to determine strengths and challenges of a duo resource/manager, in an embodiment.

FIG. 13 is a diagram illustrating example user interface showing results of strengths and challenges of a duo resource/manager, in one embodiment.

FIG. 14 is a block diagram illustrating a method to calculate an adjusted score of a competency, in one embodiment.

FIGS. 15A and 15B are exemplary tables illustrating the results of the method of FIG. 14, in one embodiment.

FIGS. 16 to 22 are diagrams illustrating example user interface resulting from the implementation of the virtual coach platform, in an embodiment.

### DETAILED DESCRIPTION

In the following description, similar features in the drawings have been given similar reference numerals. For the sake of clarity, certain reference numerals have been omitted from the figures if they have already been identified in a preceding figure.

The system described herein requires a computer program executing processing devices, each comprising at least one processor, a data storage system (including volatile and non-volatile memory and/or storage elements), at least one input device, and at least one output device. For example, and without limitation, the processing devices may include a programmable logic unit, a mainframe computer, server, and personal computer, cloud-based program or system, laptop, personal data assistance, cellular telephone, smartphone, wearable device, tablet device, video game console, or portable video game devices.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloading, magnetic and electronic storage media, digital and analog signals, and the like. The computer-usable instructions may also be in various forms including compiled and non-compiled code.

By “model”, we refer to machine learning models. The models can comprise one or several algorithms that can be chained and/or stacked and that can be trained, using training data. New data can thereafter be inputted to the model which predicts or estimates an output according to: 1) parameters of the model, which were automatically learned based on patterns found in the training data, and 2) hyper-parameters that have been optimized during the training.

In the present description, the term “data record” or “data entry” refers to a collection of data values, such as a data structure, which can be stored in memory and which holds, contains or provides access to a group of values relating to a given attribute. The values of the different fields defining a data entry can be stored permanently or temporarily, and can be transmitted or saved in database tables, arrays, files (such as ASCII, ASC, .TXT, .CSV, .XLS, etc.) and can be stored on, or transit in memory, such as registers, cache, ROM, RAM or flash memory, as examples only. The different fields can include numeric values (including dates) or character values (including free text or categorical variables) or Boolean values.

The term “resource” refers to a human resource that is dedicated to performing a task and/or a work and/or a job and/or a function within an organization. The resource can be an employee, or a trainee. A resource can be characterized and defined by attribute entries storing different parameters associated with the resource, such as age, sex, education, personality attributes.

The term “organization” refers to a company, a business sector, or an industry. Likewise, an organization can be characterized and defined by organization entries storing different characteristics of the organization, for example the field or industry, company size, type of ownership, business model, etc.

The term “team” refers to a number of resources associated to act together as a group, in order to achieve the task and/or the work and/or the job and/or the function as requested by a team manager. A team can be characterized and defined by team entries.

The term “manager” is a person who is responsible and accountable of the team, to ensure that the team, as well as each resource individually, achieve a task, a work, a job and/or a function, as defined by objectives fixed by the organization. The manager can also be responsible for ensuring that each resource in the manager's team is used at his/her best potential. In some cases, the manager can also be responsible for developing and promoting resources individually, enhancing resources productivity and motivation, addressing resources conflicts and implementing conflict resolution, ensure harmony and communication between the resources in the team and with the manager.

The term “Human Resources (HR) manager” refers to professionals in charge, for example, of developing and implementing HR strategies and initiatives aligned with the overall organization strategy, bridging managers and resources relations by addressing demands, grievances or other issues, and managing the recruitment, the selection and the dismissal processes.

The term “CEO” (or Chief Executing Officer) refers to someone with a global vision of the organization, and someone defining the main objectives and direction to follow for the organization.

The term “virtual coach” refers to a platform (or tool) and system, accessible via a user interface by the resource, the manager, the HR manager and the CEO, each of them having different access rights to different user interfaces (including graphical user interfaces). The virtual coach platform can be a cloud-based application.

The term “user interface” or “user interface device” refers to any device that can be implemented in any combination of hardware components or software components. The user interface can provide one or more inputs from a human to a computer system, examples of which include a mouse, a trackball, a joystick, a keyboard, a button, a stylus, a touchpad or a touch screen. The user interface can also provide one or more outputs from the computer system to the human, examples of which include a display (graphical), a printer, or a speaker (vocal). While only one user interface will be described herein, it is understood that the user interface can be different for the resource, the manager and/or the HR manager.

The virtual coach platform that is proposed herein allows to provide automated, consistent analyses for the management and the coaching of resources within an organization. One of the objectives is to provide a tool to managers that better select, support and coach their resources, by automating the identification of strengths and challenges of pairs (our duos) of individuals, as an example only. The virtual coach platform is also configured and trained to determine and highlight competencies of resources that are relevant to his or her job role, culture and context. The natural potential for each competency is determined by using an AI recommender system, based on scores of the resource. The scores can be derived from answers collected through questionnaires, by the AI recommender system. The level of relevancy of a competency to a given job is determined automatically, by a “best fit” analysis with the job and the organization profiles.

Because the improved virtual coach platform is based on artificial intelligence rather than human assessment, the virtual coach platform provides more robust and consistent recommendations, more reliable data, and avoid any cognitive bias, such as perceptual or judgmental bias.

One of the main challenges in implementing this new virtual coach platform is the ability to obtain a meaningful set of data to make accurate automated recommendations, in particular when initially starting to use the system (“cold start problem”). To solve this problem, a synthetic dataset can be generated. This synthetic dataset is artificially created based on business rules, or scientific data, or historical data, generated and validated by researchers, psychologist knowledge and/or human resources professional knowledge. For example, the synthetic data can comprise the expected compatibility between an individual A and an individual B, based on the psychometrics attributes of individuals A and B and the hierarchical relationship between individuals A and B. The synthetic dataset thus comprises thousands of simulations for which, in each simulation, a specific output is generated for a given set of inputs, based on the deterministic rules. The AI model(s) can then be initially trained on the synthetically generated dataset (synthetic dataset) so that the set of deterministic rules that have been developed and refined based on a mix of practician experience and scientific experiments can be transferred (“learned”) by the one or more machine learning (ML) models of the AI-recommender system. Once trained, the ML-based AI recommender system can be progressively updated and retrained based on real data inputs, such as feedback provided on outputs that the AI recommender system generates (such as suggested recommendations, actions, alerts). The feedback can be collected progressively, as end users use the virtual coach platform. The feedback collected constitute a field dataset. This field dataset can be combined with the synthetic dataset and the ML model can be retrained on the augmented dataset to improve its performance.

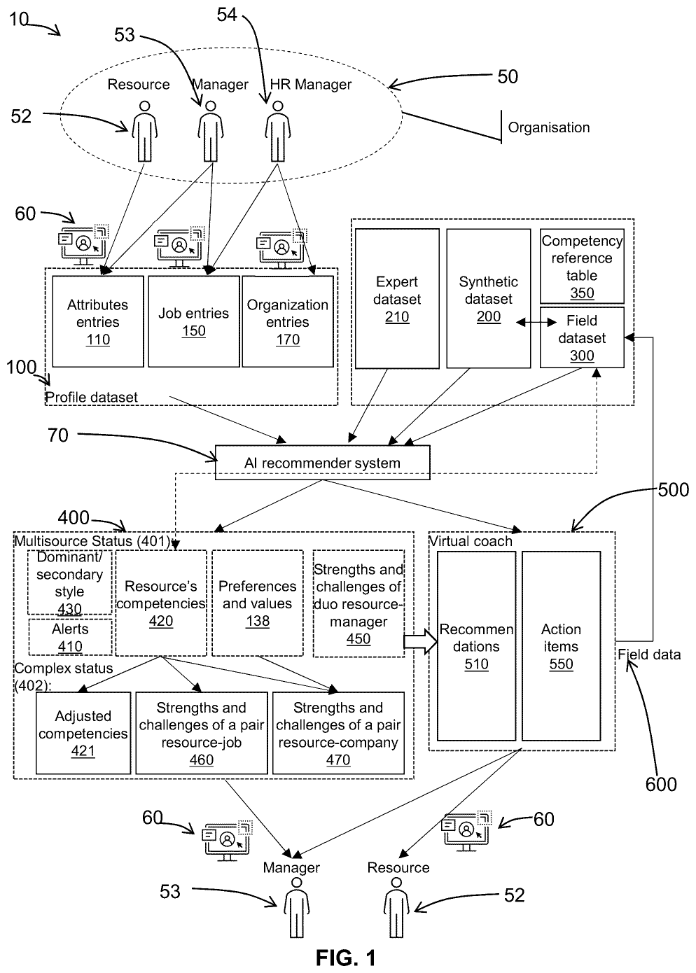

FIG. 1 shows a block diagram illustrating an embodiment of a method and a system of a virtual coach platform for automating assessment compatibility of resources within an organization.

According to different embodiments, the virtual coach platform can automatically assess compatibility of resources within an organization, of the resource with his/her manager, of the resource with a team in which the resource belongs to, of the resource with a given job assigned to the resource, and/or of the resource with the organization. “Compatibility” can be determined by first determining personality traits and competencies of the different individuals. The competencies can be determined or predicted by the AI-recommender system, using deterministic rules and/or a trained machine learning model. From the personality traits, dominant and secondary styles can be derived, as well as strengths and weaknesses of a duo (or pair) of individuals. From the competencies, the strengths and weaknesses of an individual for a given job profile; or of an individual within a given company can be derived, as will be explained in more detail below.

In use, an organization 50 must be first defined, by inputting different types of parameters that will form the organization entries. The organization will comprise at least one resource 52, one manager 53 and one HR manager 54, each defined by different parameters specific to their type, forming attribute/individual entries. Several resources 52 can be considered as part of a team, managed by the same manager 53. A CEO can also be defined as a specific type of individual and be defined by specific parameters. In some embodiment, a plurality of organizations 50 can be defined and inputted within the virtual coach platform. For sake of clarity, the explanations below will be given for only one resource 52 within only one organization and without CEO.

### Building a Profile Dataset

### Attribute Entries

The first step of the method consists of building up a profile dataset 100. In some embodiment, the profile dataset 100 comprises attributes entries 110, job entries 150 and organization entries 170.

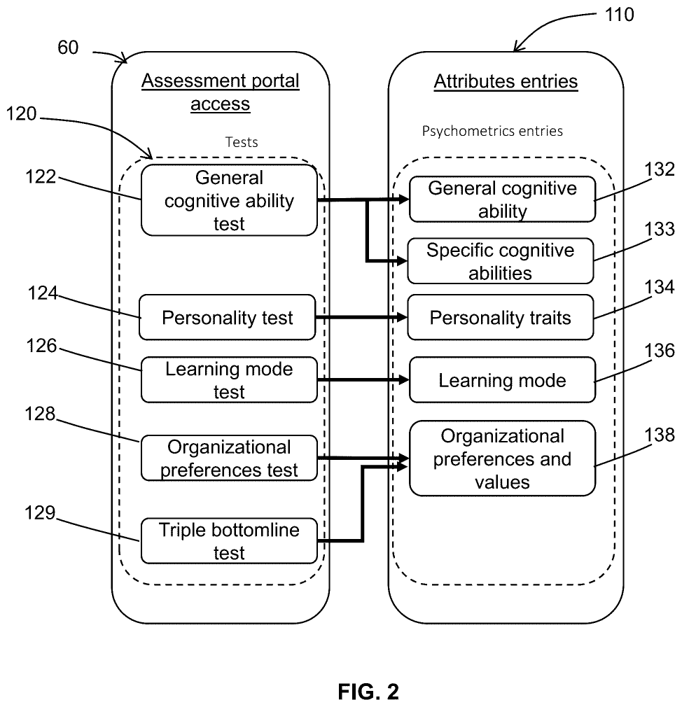

A user interface 60 includes an assessment portal access, accessible by the resource 52, to collect results of a plurality of tests to populate the attributes entries 110. For example, as shown in FIG. 2, a plurality of tests 120 can comprises psychometric tests or evaluations such as general cognitive ability test 122, personality test 124, learning mode test 126, organizational preferences test 128, or triple bottom line test 129. The results of these tests (including free-text or selections from multiple choice) can be collected via the user interface 60 as attribute entries 110, or psychometric attribute entries.

The general cognitive ability test 122 can consist of a questionnaire that measures the resource's cognitive capacity. An example of the test consists of a plurality of questions (e.g., 50 questions) to evaluate the resource's ability to learn and the resource's capacity to quickly understand complex ideas. As an example, the questions can be grouped into six (6) fields or dimensions: numerical aptitude, deductive aptitude, verbal aptitude, analogical aptitude, orientation aptitude and spatial aptitude. The results of the general cognitive ability test 122 can be compiled into: a general cognitive ability 132 and/or specific cognitive abilities 133. The general cognitive ability 132 consists of a single score or rating, as a compilation of all of the (6) fields. The specific cognitive abilities 133 comprises a specific score or rating for each of the (6) fields considered during the cognitive ability test 122. The score can be a value ranked on a scale. For example, on a scale from 1 to 9, for the numerical aptitude, the more the rating will be closer to 1, the less the resource has numerical aptitude, and the more the rating will be closer to 9, the more the resource has numerical aptitude.

The personality test 124 allows to check the strengths and natural reflexes as well as the disposition to behave in a particular way. The personality test 124 can represent dispositions of the resource or of the manager, segmented into a personality inventory subset and which operationalizes a personality model that describes the variation in personality structure based on different factors. In some embodiment, the personality test 124 can be based on the Big Five Theory¹, consisting of evaluating a plurality of personality scales (e.g., 14 personality scales) grouped under the five major factors of this theory, that are, for example, openness, conscientiousness, agreeableness, extroversion and neuroticism. The personality test 124 results can be compiled into personality traits 134 for the resource. In some embodiment, the personality traits 134 can be classified by dividing the distribution of results on a scale of nine (9) classes. This classification method is a statistic method for scaling test scores on a nine-point standard scale with a mean of five and a standard deviation of two. This classification method, named STAndard NINE, or Stanine², is one of the standard personality classifications used in the domain, but other alternative classification methods can be used. The classification of the resulting Stanine of the personality traits 134 can be presented on a bipolar scale, i.e., a scale having two opposite poles. The more the resource scores towards one extreme pole (whether it be to the left, therefore closer to 1, or the right, closer to 9), the more that resource will move away from the average and have the characteristics of the trait being represented by that side of the pole. The closer the score is to 5, the closer that resource's results correspond to the average of the population for that given dimension. ¹ Goldberg, L. R. (1990). An alternative “description of personality”: The big-five factor structure. Journal of Personality and Social Psychology, 59, 1216-1229.² Boydsten, Robert E. (Feb. 27, 2000), Winning My Wings

The personality traits 134 can comprise a plurality of fields, each field having a specific field name and a specific rating (data). For example,

TABLE 1
personality traits rating

| Field # | Major factor | Field name and poles (1/9) | Rating |
|---|---|---|---|
| 1 | Openness | Change/familiar | 9 |
| 2 | Conscientiousness | Spontaneity/organization | 6 |
| 3 | Agreeableness | Conciliation/assertiveness | 2 |
| 4 | Extraversion | Solitude/social relationships | 3 |
| 5 | Emotional stability | Anxiety/resistance to stress | 8 |

It is understood that any other method for assessing personality traits can be used, and the Big five theory is only one example of them.

The learning mode test 126 can consist of a questionnaire to evaluate resource's preferred learning mode or style and how the resource acquires and assimilates information. The results of the learning mode test 126 can be compiled into a learning mode or learning mode 136 for the resource. The learning mode 136 comprises a score or rating. The score can be a value ranked on a bipolar scale, as described above. In some embodiment, the learning mode 136 can comprise only one field (named learning mode) with a bipolar scale having two opposite poles: conceptual and practical. The rating on this bipolar scale indicates if the resource is closer from a conceptual learning mode or style (learning by thinking such as reading books or articles, conceptualizing a project, using theories) or a practical learning mode or style (learning by doing such as performing practical exercises, learning in action).

The organizational preferences test 128 can consist of a questionnaire to evaluate the values, interests and preferences of the resource. The results of the organizational preferences test 128 can be compiled into organizational preferences and values 138. The organizational preferences and values 138 can be influenced by the environment, the culture and beliefs and may be dynamic, i.e., may change over time. The scores obtained for each organizational preferences and values 138 can also be presented on a bipolar scale, as described above.

The plurality of tests 120 can further comprises a triple bottom line test 129, to assess the importance that the resource gives to sustainable development and how much they aspire to work for a company adhering to social and environmental values. Among other things, this test is very valuable for employers who have a social and environmental culture and who are looking for resources motivated by these values. When a resource works in a company or organization that shares his values, the resource will tend to feel more engaged, motivated and satisfied. The results of the triple bottom line test 129 are also compiled into the organizational preferences and values 138 for the resource. The scores obtained for each field of the triple bottom line test 129 can be ranked on a specific scale (for example from 1 to 9 in the Stanine method), with the lower ratings (closer to 1) being representative of a low interest for the value, and the higher ratings (closer to 9) being representative of a high interest for the value. In the example shown below, the organizational preferences and values 138 can comprise at least three (3) fields dedicated to the results of the triple bottom line test 129, each field having a specific field name and a specific rating (data). For example,

TABLE 2
triple bottom line test results rating

| Field # | Field name | Rating |
|---|---|---|
| 1 | Social impact | 9 |
| 2 | Ecological footprint | 6 |
| 3 | Sustainable development | 2 |

The assessment portal access of the user interface 60 can also be accessible by the manager 53, the user interface 60 collecting results of the personality test 124 and the learning mode test 126 completed by the manager, the results being compiled into personality traits 134 and a learning mode 136 for the manager.

Therefore, the attributes entries 110 can comprise parameters defining: the general cognitive abilities 132 for the resource 52, the specific cognitive abilities 133 for the resource 52, the personality traits 134 for the resource 52, the personality traits 134 for the manager 53, the learning 136 for the resource 52, the learning 136 for the manager, and the organizational preferences and values 138 for the resource 52.

In some embodiment, the user interface 60 can display the resulting resource's attributes entries 110 onto a result portal access, accessible by the resource 52, the manager 53 and the HR manger 54.

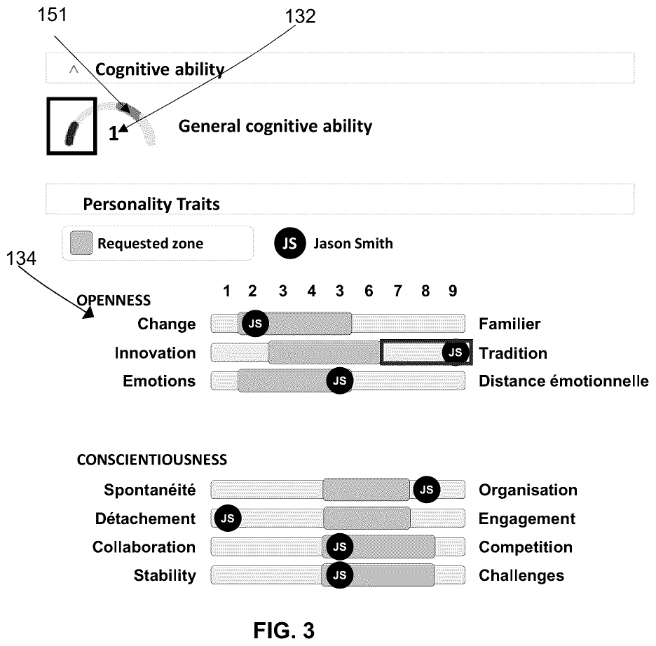

Referring to FIG. 3, an exemplary result portal is shown, for a resource named Jason Smith. In this example, the general cognitive ability 132 and the personality traits 134 have been classified based on the Stanine standard. The result portal displays the score obtained for general cognitive ability (in this case, the score is 1), as well as the score obtained for several fields of the personality traits. In the example displayed, the results are the following:

TABLE 3
example of personality traits rating for Jason Smith

| Field # | Major factor | Field name and poles (1/9) | Rating |
|---|---|---|---|
| 1 | Openness | Change/familiar | 2 |
| 2 | Openness | Innovation/tradition | 9 |
| 3 | Openness | Emotional openness/ | 5 |
| | | Emotional distance | |
| 4 | Conscientiousness | Spontaneity/organization | 8 |
| 5 | Conscientiousness | Disengagement/Commitment | 1 |
| 6 | Conscientiousness | Collaboration/Competitive | 5 |
| | | Spirit | |
| 7 | Conscientiousness | Stability/challenge | 5 |

### Job Entries

The user interface 60 can also include a manager access tab or page, accessible by the manager 53 and by the HR manager 54, to collect job entries 150 associated with a job profile. The job entries 150 can be generic or personalized. The job entries 150 can comprise job related information and required attributes. For example, the job entries 150 can comprise position characteristics and requirements, job fit, domain, role, team, or manager.

In particular, the job entries can comprise parameters defining a job fit 252, which are specific requirements in terms of general cognitive ability 132 and competencies 420 for a specific job function. In some embodiment, the personality traits 134 can also be considered. The job fit depends on the job function and should not be impacted by the organization. For example, requested zones of general cognitive ability for a financial advisor should be the same in all the organization for a generic job fit. This job fit 252 will be used to determine complex status 402, as will be further described later.

For example, in the example shown in FIG. 3, if Jason Smith is assigned in a job of financial advisor, the job entries 150 can consist of identifying a requested zone 151 of the rating for each of the fields, for a specific job function. In this case, for the general cognitive ability 132, with a score of 1, Jason Smith is outside of the requested zone 151 of [6-7].

### Organization Entries

In addition, the user interface 60 can include a HR access tab or page, accessible by the HR manager 54, to collect organization entries 170. The organization entries 170 can comprise specificities of the business context, organization context, activity domain, market, situation, issues, challenges, practices, retention plan and hiring context (such as the domain, business context, benefit offer, retention practices, etc.).

In particular, the organization entries can comprise a culture fit 254, which are specific requirements (requested zone) defined by parameters of general cognitive ability 132, personality traits 134, and/or competencies 420 for a specific culture of the organization. The culture fit depends on the organization structure and should not be impacted by the job function. For example, requested zones for each identified competencies within the same organization should be the same for a financial advisor or for a technician. This culture fit 254 will be used to determine complex status 402, as will be further described later.

In some embodiment, the user interface 60 can further include a context assessment tab or page, to collect a context of the organization, defined by specific organization parameters. The context assessment tab or page can be accessible by the resource 52, the manager 53, and the HR manager 54. The results of the context assessment or context questionnaire can be compiled into a context-filter 256. The context-filter 256 can comprise at least 4 different fields, such as context of change, context of complexity, context of importance/pressure to succeed, and context of urgency to act. The results of the context assessment reflect the context of the company at a given moment in time. For better accuracy of this value, it is recommended to perform an updated context assessment on a regular basis, such as every 6 months for example. This context-filter 256 will be used to determine complex status 402, as will be further described later.

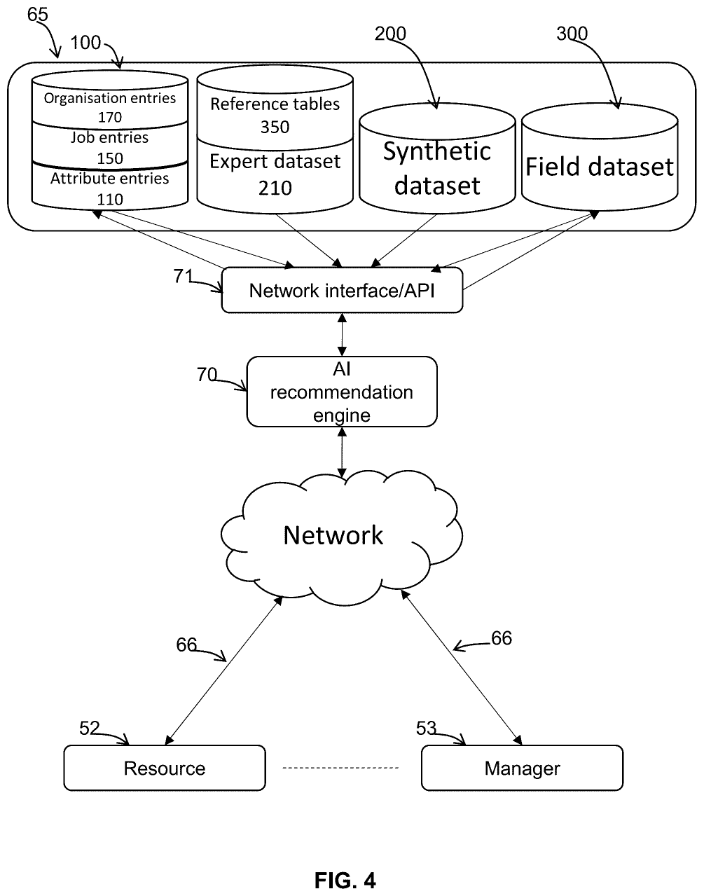

As shown in FIG. 4, the attributes entries 110, the job entries 150 and the organization entries 170 collected as described above via the user interface 60 are transmitted to a data storage 65 for instance by a network transmission link 66 thanks to networking equipment such as routers and switches, including for instance the Internet. The virtual coach platform accesses the attributes entries 110, the job entries 150 and the organization entries 170 stored in database storage 65 via Application Programming Interfaces (APIs) 71. The APIs can access, store and retrieve the entries from the data storage 65.

The data storage 65 is also configured to store persistently the different dataset, such as an expert dataset 210, a synthetic dataset 200, reference tables 350 and field dataset 300, as will be further described below.

The following step of the method consists of retrieving from a given profile dataset 100, attributes entries 110 associated with a given resource 52 and a manager 53, job entries 150 associated with one or more job profiles, and organization entries 170 associated with the organization 50, that are stored into the data storage 65, and to input all these entries in an Artificial Intelligence (AI) recommender system 70.

### Determining Multisource Status Based on an Expert Dataset

In a first embodiment, the AI recommender system 70 can be a recommender algorithm based on an expert system. In this embodiment, the AI expert system is configured solely based on static business rules or predetermined rules derived from scientific studies. The AI recommender system 70 comprises a set of human-coded rules that result in pre-defined outcomes, such as ‘if-then’ coding statements, encoded in an expert dataset 210. The recommender algorithm can take a plurality of source to define a single outcome, therefore determining multisource status based on the expert dataset.

The expert dataset 210 can comprise a plurality of expert sub-dataset, for each of the multisource status to be determined, as will be explained below.

The expert dataset 210 and sub-dataset are built based on static business rules derived from scientific and expert studies, and/or based on business rules.

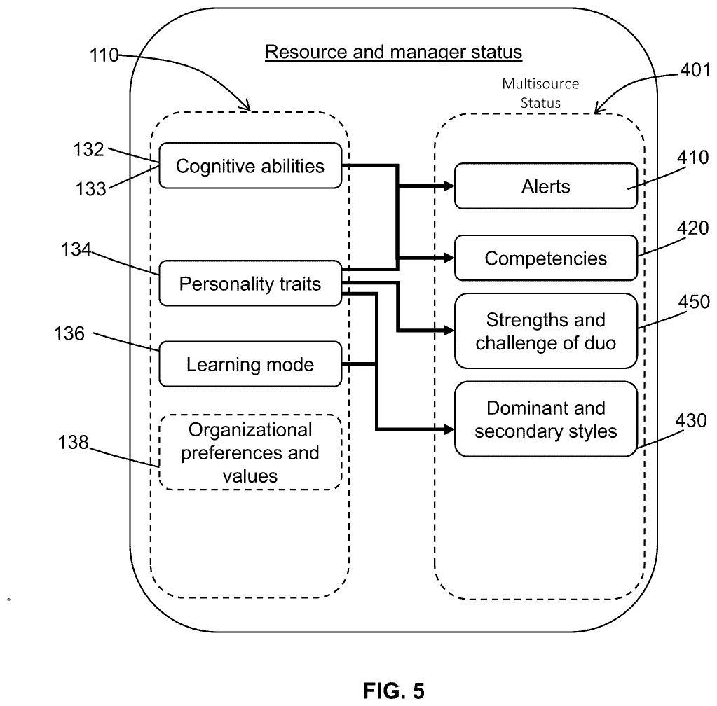

Referring to FIG. 5, there is shown examples of multisource status 401 that can be generated by the AI recommender system 70 based on expert sub-dataset, such as alerts 410, competencies 420, dominant and secondary styles 430 for the resource 52, dominant and secondary styles 430′ for the manager 53, and strengths and challenges of the duo 450 formed by the manager and the resource.

In particular, a combination of at least two attribute entries 110 are used as an input for each multisource status 401.

### Competencies

The competencies 420 are personal characteristics such as values, attitudes, personality traits, knowledge, skills and abilities. The competencies 420 are defined by considering the general cognitive ability 133 of the resource and the personality traits 134 of the resource as an input. The competencies are measurable characteristics of the resource associated with the success in the execution of his/her tasks. The competency may be a behavioural or technical skill, an attribute, or an attitude. In the example given, sixty (60) competencies will be generated. The table below lists an example of the 60 competencies, regrouped in 5 main categories: analysis, discipline, energy, influence and relation.

TABLE 4
example of competencies

| Competency | | |
|---|---|---|
| # | Categories | Competencies |
| 1 | Analysis | Adaptability |
| 2 | | Analyse and Process |
| 3 | | Information |
| 4 | | Product and Client File |
| 5 | | Analysis |
| 6 | | Learning |
| 7 | | Creativity |
| 8 | | Obtain Information |
| 9 | | Problem Solving |
| 10 | | Tolerance to Ambiguity |
| 11 | | Strategic Vision |
| 12 | Discipline | Quality Control and Conformity |
| 13 | | Efficiency in Telecommuting |
| 14 | | Ethics |
| 15 | | Conformity Assessment |
| 16 | | Reliability |
| 17 | | Project Management |
| 18 | | Priority Management |
| 19 | | Accountability |
| 20 | | Organization and CRM Documentation |
| 21 | | Organization and Follow- ups |
| 22 | | Strategic Planning |
| 23 | | Sales Prioritization |
| 24 | | Rigor and Respect of Procedures |
| 25 | | Respect of Rules and Procedures |
| 26 | | Attention to Detail |
| 27 | | Client Follows-ups |
| 28 | Energy | Ambition |
| 29 | | Self-Confidence |
| 30 | | Entrepreneurship |
| 31 | | Stress and Emotions |
| 32 | | Management |
| 33 | | Action-Oriented |
| 34 | | Results-Oriented |
| 35 | | Openness to Criticism and Coaching |
| 36 | | Perseverance |
| 37 | Influence | Cold Calls |
| 38 | | Capacity to Close a Sale |
| 39 | | Capacity to Inform |
| 40 | | Capacity to Negotiate |
| 41 | | Capacity to Influence |
| 42 | | Managerial Courage |
| 43 | | Delegation |
| 44 | | Innovation Management |
| 45 | | Team Leadership |
| 46 | | Decision Making |
| 47 | | Political Sense |
| 48 | Relation | At Ease with the Public |
| 49 | | At Ease in Networking |
| 50 | | Interpersonal Communication |
| 51 | | Understanding Others |
| 52 | | Potential Development |
| 53 | | Efficiency in Networking |
| 54 | | Conflict Management |
| 55 | | Self-Control |
| 56 | | Team Mobilisation |
| 57 | | Presenting in Front of a Group |
| 58 | | Customer Service |
| 59 | | Teamwork |
| 60 | | Collaboration with a Team |

For each competency, a raw score is defined based on a competency expert sub-dataset. This sub-dataset defines the rules to assign the raw score based on the score obtained in the general cognitive ability 133 plus the raw score obtained in a selection of personality traits 134.

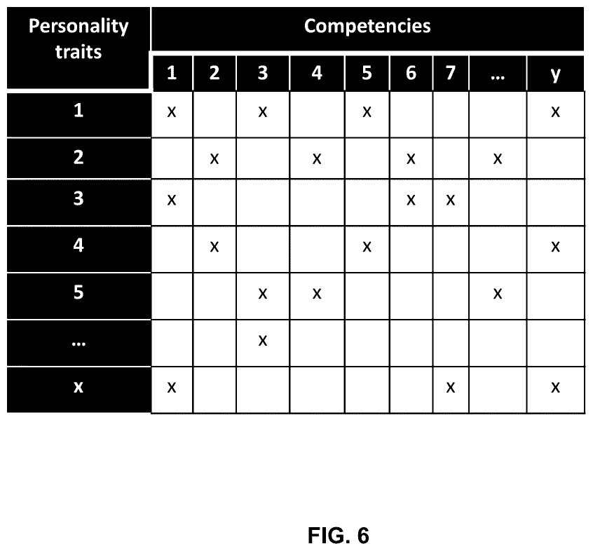

Referring to FIG. 6, an exemplary table is shown which captures expert rules for the personality traits scores that should be considered and added to the general cognitive ability in the equation to calculate the raw score of a given competency. For example, the raw score of the competency #5 will be given by the sum of the raw score of the general cognitive aptitude plus the raw score of the personality trait #1 plus the raw score of the personality trait #4.

In some embodiment, the raw score of each competency can be calibrated or adjusted, as will be further described later (complex status 402).

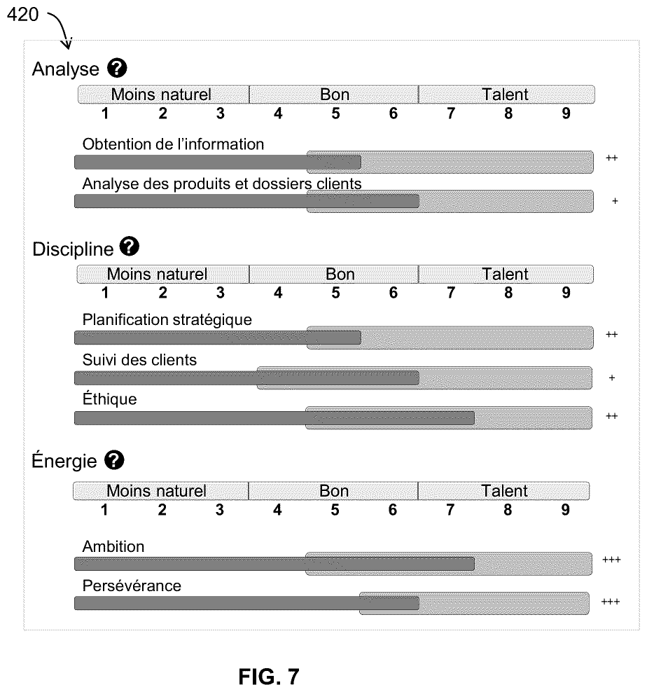

Referring to FIG. 7, an exemplary display of the result portal is shown. In this example, the competencies have been sorted on a Stanine scale and can be presented on a rating scale, i.e. a scale rated from a lower score to a higher score (for example from 1 to 9), with a first third (e.g. 1 to 3) being “less natural” competency, a second third (e.g. 4 to 6) being a “good” competency, and a third third (e.g. 7 to 9) being a “talented” competency. It is noted that in the embodiment shown, the score for each competency is not the raw score but an adjusted score or normalized score, as will be further detailed later.

### Alerts

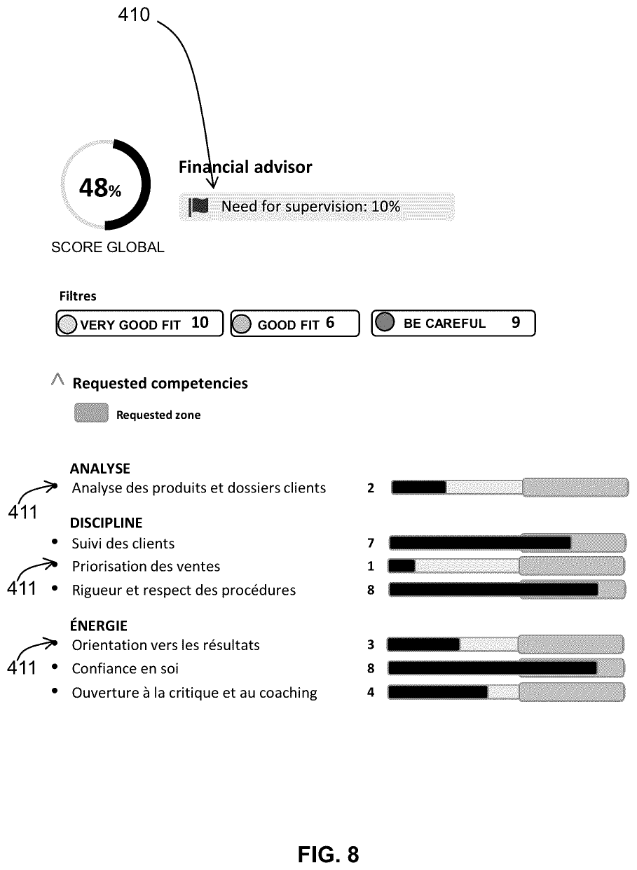

The alerts 410, or challenges, or problematics, are indicators of vulnerability of the resource 52, i.e., they identify the attributes or characteristic of the resource 52 that requires vigilance. Referring to FIG. 8, an exemplary display of the result portal is shown. The result portal displays the score obtained for each competency. The alerts can be a combination of unfavourable attributes 410 that may require specific advice (e.g. “need for supervision”). The alerts 410 are determined based on a combination of the general cognitive ability 132 and the personality traits 134 of the resource. The alerts 410 are triggered by extreme personality traits 134 or extreme general cognitive ability 132 of the resource 52. For example, if one dimension of the personality traits 134 or the general cognitive ability 132 of the resource scores at one extreme pole of the (bipolar or linear) scale, it may trigger an alert.

The alerts 410 are defined based on an alert expert sub-dataset, where several alerts are defined for predetermined general cognitive ability 132 and the personality traits 134 of the resource and/or of the manager.

Also, the alerts 410 can concern some of the challenges of the duo and can be generated when problematic discrepancies or problematic similarities between the personality traits 134 of the resource vs the personality traits of the manager 134′ is identified. For example, a problematic discrepancy can be a traditional resource associated with an innovative manager, and a problematic similarity can be both resource and manager being competitive.

The alerts can also comprise problematic competencies as a challenge of the specific resource in the specific company based on the score obtained in each competency (natural talent) versus requirements of the job, the culture or the context.

### Dominant and Secondary Styles

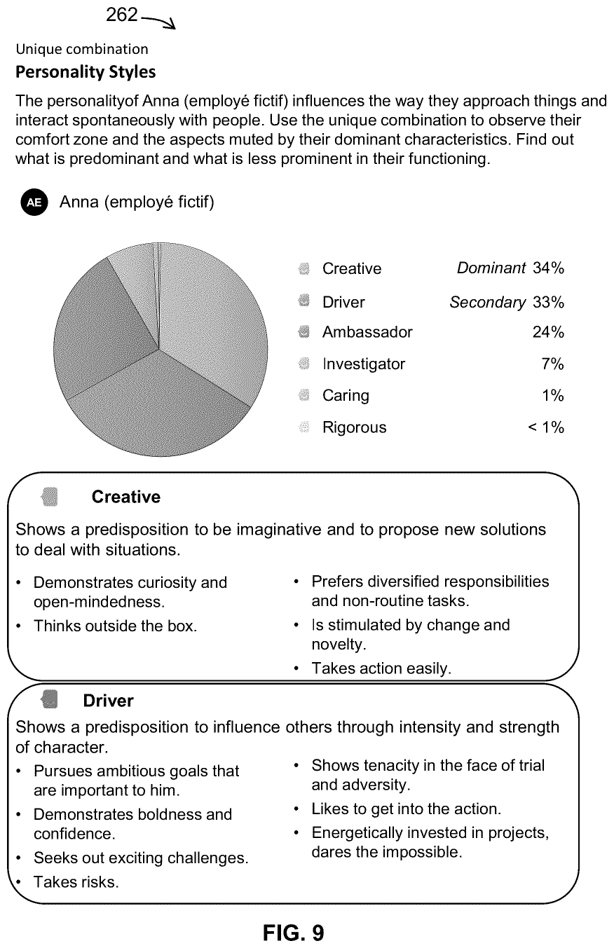

Referring to FIG. 9, an exemplary display of a resource profile 262 is shown. In this example, the resource styles have been generated by the AI recommender system 70, based on the ranking of each personality traits 134 and the learning mode 136, and based on an expert sub-dataset 210, to define a score for each style or profile field, such as creative, driver, ambassador, investigator, caring and rigorous.

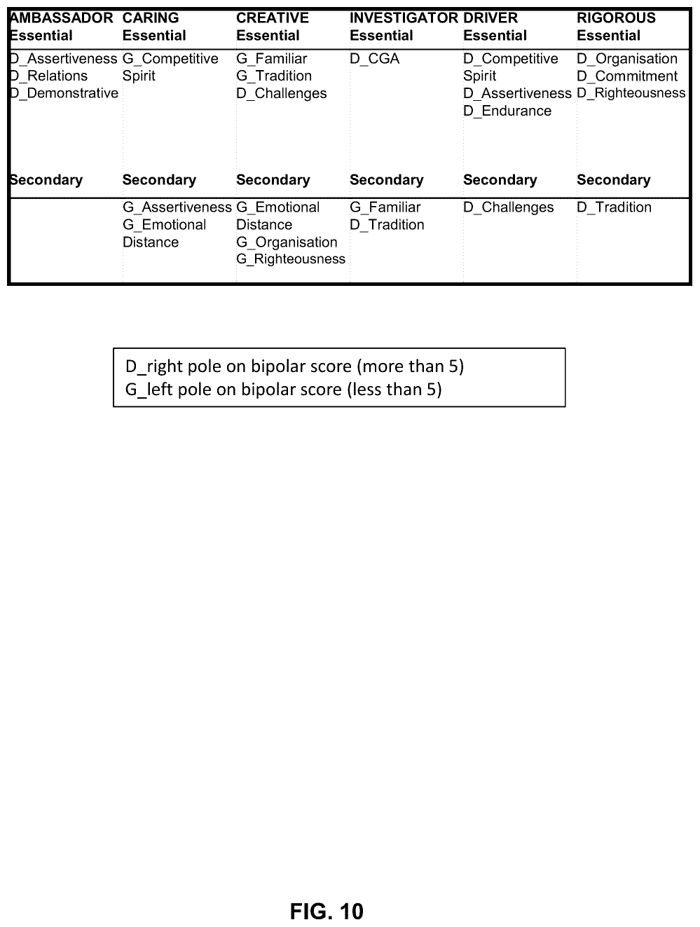

FIG. 10 shows an example of an expert sub-dataset to determine the style or profile based on the rating of each personality traits listed in the table as well as the learning mode 136.

For each of the resource 52 and the manager 53, the style with the highest score will be defined as a dominant style, and the style with the second highest score will be defined as a secondary style. Therefore, the dominant and secondary styles 430 is defined for the resource 52, and the dominant and secondary styles 430′ is defined for the manager 53.

### Strengths and Challenges of Duo

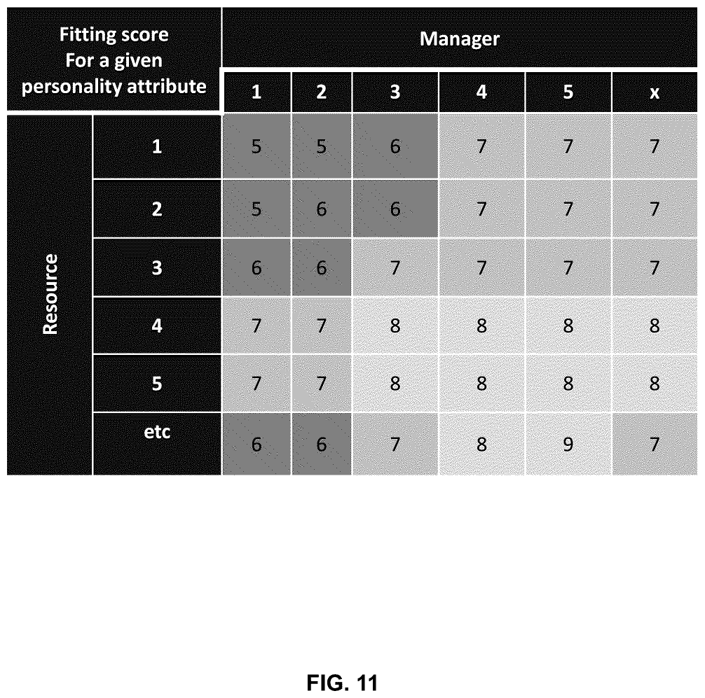

Referring to FIG. 11, an exemplary table, or matrix, is shown which captures expert rules for a given personality attribute or traits. The columns show a rating from 1 to x of a manager's attribute, while the lines show a rating from 1 to x of a resource's attribute, the manager's attribute evaluated being the same as the resource's attribute. In FIG. 11, the personality attribute could be for example, innovation/comfort (based on the double scale explained above). A fitting score is a function of the score of the manager's attribute versus the score of the resource's attribute. For example, if the score of the manager's attribute is 3 and the score of the resource's attribute is 4, therefore the resulting fitting score will be 8. In another example, if the score of the manager's attribute is 4 and the score of the resource's attribute is 3, therefore the resulting fitting score will be 7. There is no symmetry between the score of the manager's attribute and the score of the resource's attribute, because there is a hierarchical relationship between the manager and the resource. In some embodiment, a color code can be applied to the fitting score, to visually interpret the fitting score results. In the example shown, a fitting score result of 7 is highlighted in middle grey (could be yellow), a fitting score result higher than 7 is highlighted in light grey (could be green), and a fitting score result smaller than 7 is highlighted in dark grey (could be red). The fitting score indicates the propensity of compatibility between the resource and the manager, on this specific attribute.

From the fitting score determined for each personality traits 134, the AI recommender system 70 can provide an indication of strengths and challenges 450 of a duo formed by the given resource 52 and the manager 53. This process must be repeated for each personality attribute entry, such that each personality attribute entry will be assigned a score. The table presented in FIG. 11 shows only the fitting score expected for the given personality attributes. Therefore, it is understood that as many tables as given attributes will be stored in the expert dataset 210 of the data storage 65.

The personality attribute entries will be ranked according to their scores. The personality attribute entries having the highest scores will represents the strengths, and the personality attribute entries having the lowest scores will represents the challenges of the duo.

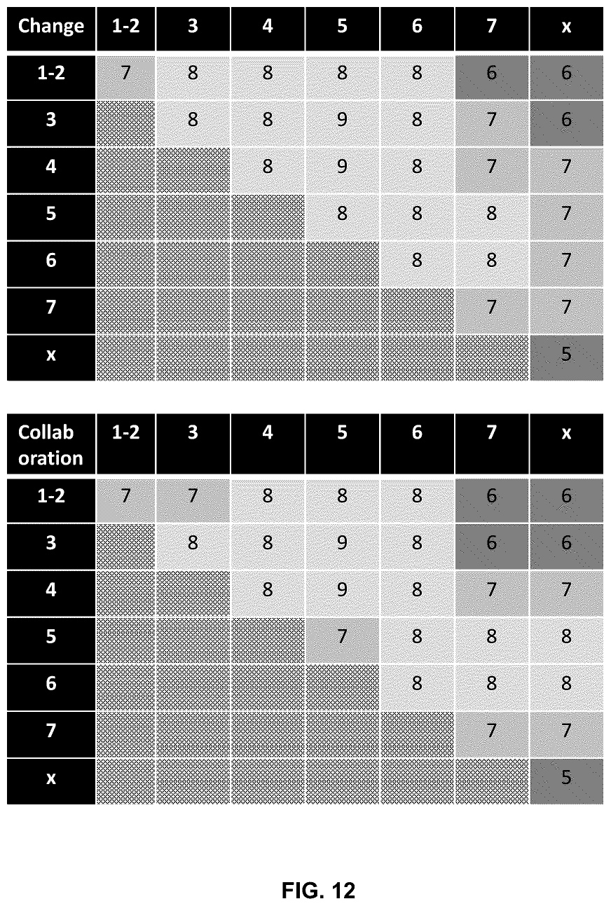

FIG. 12 shows two examples of matrices which capture the expert rules for two different personality traits, “change” and “collaboration”. In this example, there is no hierarchical relationship and both columns and lines show a rating of two resources attributes, the two resources being at the same hierarchical level. The fitting score for each attribute (for example the change and the collaboration) are provided in the table shown in example, as a result of the rating of the resource attribute

The columns show a rating from 1 to x of a first resource's attribute, while the lines show a rating from 1 to x of a second resource's attribute, the first resource's attribute evaluated being the same as the second resource's attribute. A fitting score is determined as a function of the score of the first resource's attribute versus the score of the second resource's attribute.

From the fitting score determined for each dimension of the personality traits, the AI recommender system 70 can provide an indication of strengths and challenges 450 of two resources within the same team, at a same hierarchical level.

The table presented in FIG. 12 shows only the fitting score expected for two given personality attributes (change and collaboration). Therefore, it is understood that as many table as given attributes will be stored in the expert dataset 210 of the data storage 65.

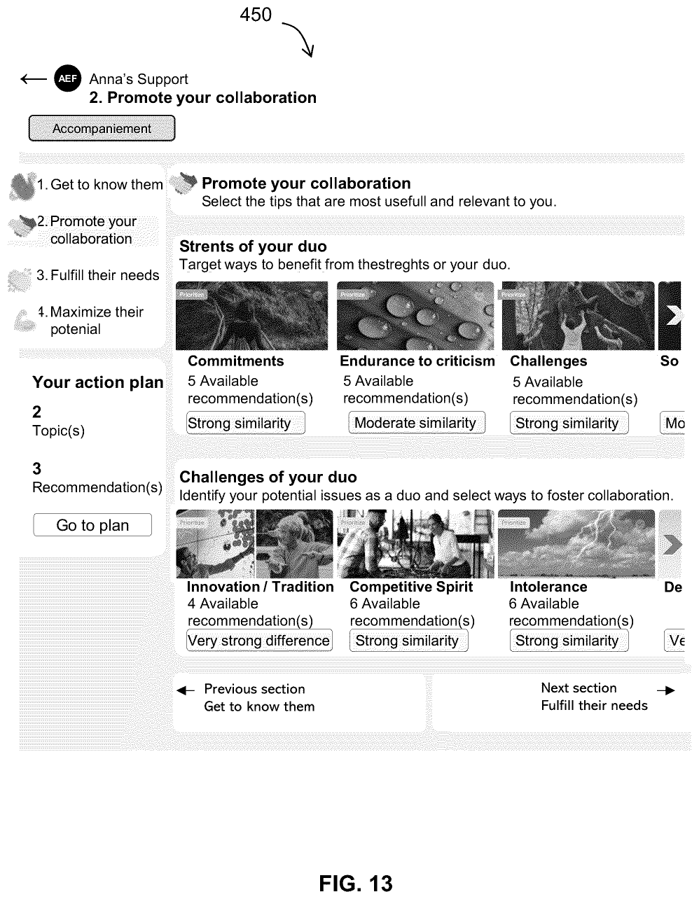

Referring to FIG. 13, an exemplary display of an indication of strengths and challenges 450 of a duo formed by the given resource 52 and the manager 53 is shown. In this example, each strength and each challenge are rated and displayed from “very strong”, “strong”, “moderate”, “low” and “very low”, based on the results obtain in the fitting score as described above. The challenges can result from a problematic discrepancy (e.g., a traditional resource with innovative manager) or problematic similarity (e.g., both resource and manager that are too competitive).

### Determining Complex Status

In some embodiment, the AI recommender system 70 can be a recommender algorithm based on complex status. In this case, the AI recommender system 70 can determine a normalized competency score (different from the Stanine defined above) by adjusting the raw competency score obtained previously based on a context and references tables. The AI recommender system 70 can also classify the competencies (by decreasing order of importance) for a specific resource to perform (or to shine) in a specific job and/or in a specific organization, by adjusting the competency score with specific parameters, such as a job fit, a culture fit, or a context filter.

### Normalized Competency Score

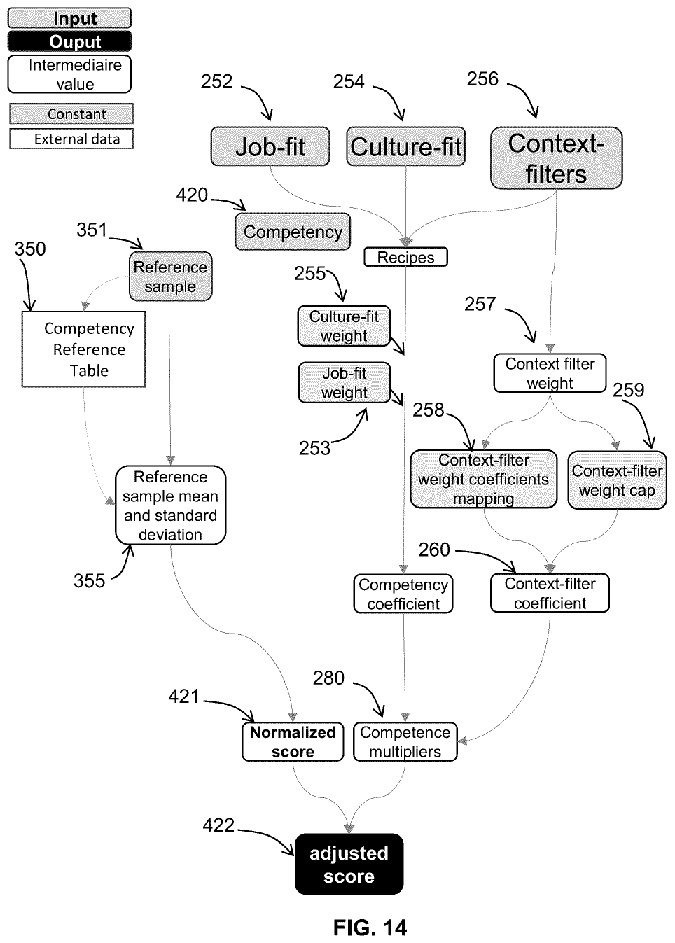

Referring to FIG. 14, there is shown a method to calculate an adjusted score 422 of a competency 420. This method is shown only for one competency and will have to be repeated for each of the competencies.

To calculate the normalized competency score 420, the first step consists of retrieving from the data storage 65 a competency reference table 350. This competency reference table 350 has been built and stored in the data storage 65 by collecting the results of all the resources that have competed the plurality of tests 120. The competency reference table can comprise a plurality of sub-tables, where each sub-table corresponds to a certain version of the plurality of tests 120 in a certain language. The reference sample 351 is the identifier allowing the selection of the corresponding competency reference table 350. For example, the reference sample 351 can direct to the competency reference sub-table corresponding to the revision V6 of the plurality of tests 120, in French.

The competency reference table (or sub-table) that has been retrieved by the AI recommender system 70, comprises a reference sample mean and standard deviation 355 identified as:
μ for the mean, and
δ for the standard deviation.

For example, the normalized score for each competency can be determined by calculating a z-score, but it is understood that other methods could be considered to determine the normalized score.

From this competency reference table (or sub-table), we can also determine the target (M), given by the z-score corresponding to the 99.99 quantile, which is virtually the highest achievable z-score.

The normalized score 421 using the z-score formula will be given by:

$$Normalize score S = 1 - ( D / ( 2 * M ) ) ,$$

With:
D=distance to the target=M−Z
z is the z-score, with

$$z = \frac{\overline{( x - μ )}}{δ}$$

X is the initial competency score or raw score.

### Fit of the Resource in a Job and in an Organization

Still referring to FIG. 14, a series of parameters, such as such as a job fit 252, a culture fit 254, or a context filter 256 can be used in the calculation of a competency multiplier 280, to adjust the competency score based on a specific job and/or in a specific organization.

The job fit 252 can be determined based on the job entries 150 retrieved from the data storage 65. In some embodiment, the job fit 252 can be directly stored as a table in the job entries 150 stored in the data storage 65. The job fit consists of a job fit weight 253 that can be applied for each competency, for a given job. The weight can be a weight selected as any integer between 1 to 3.

For example, for a job function of financial advisor, the competencies #3, #7 and #23 will have weight of 3, the competencies #1 and #34 will have weight of 2, and all other competencies will have a weight of 1.

Similarly, the culture-fit 254 can be determined based on the organization entries 170 retrieved from the data storage 65. In some embodiment, the culture-fit 254 can be directly stored as a table in the organization entries 170 stored in the data storage 65. The culture-fit 254 consists of a culture fit weight 255 that can be applied for each competency, for a given organization. The weight can be a weight selected as any integer between 1 to 3.

For example, for the organization LAMBDA, the competencies #33, #42 and #57 will have weight of 3, the competencies #22 and #14 will have weight of 2, and all other competencies will have a weight of 1.

The context filter 256 can be determined based on the results of the context assessment as previously described. Either the context assessment results, or the resulting context filter can be stored as a table in the organization entries 170 stored in the data storage 65. For each of the 4 fields of the context filter 256, i.e., context of change, context of complexity, context of importance/pressure to succeed, and context of urgency to act, a specific context-filter weight 257 can be defined to be applied for each competency, for the manager role and for the resource role. The context filter weight 257 can be further adjusted with a bonus coefficient, for example if the same competency is weighted (i.e., weight higher than 2) similarly in more than one field of the context filter 256.

In some embodiment, the context-filter weight 257 can also be limited or cap by a context-coefficient weight cap 259, to ensure that the context-filter weight 257 does not have a disproportionate importance compared to the job fit weight and the culture-fit weight.

A mathematic rule defined as a function of the context filter weight 257, the context-filter bonus coefficient 258, and the context-filter weight cap 259 can be used to determine the resulting context-filter coefficient 260 for each field of the context filter and for each competency.

Another mathematic rule can be used to determine the resulting competence multiplier 280, as a function of the competence multipliers 280 and the normalized score 421 to obtain the adjusted score 422 for each competency. The same process of calculation will be repeated for each competency.

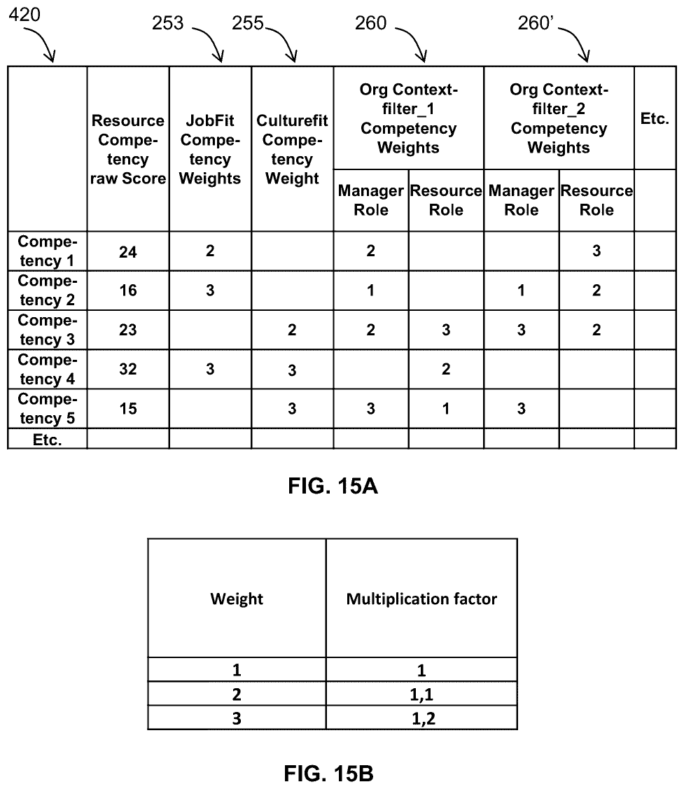

FIG. 15A shows an example of table of weights to be applied to the resource competency raw score 420, where the lines list all the competencies to be evaluated. The first column shows the resource competency raw score, the second column shows the job fit weight 253 applicable for each competency, the third column shows the culture fit weight 253 applicable for each competency. Columns 4 and 5 shows the context filter weight 260 for the first field of the context filter (e.g., context of change), with column 4 showing the weight applicable to a manager role and column 5 showing the weight applicable to a resource. Columns 6 and 7 shows the context filter weight 260′ for the second field of the context filter (e.g., context of complexity), with column 6 showing the weight applicable to a manager role and column 7 showing the weight applicable to a resource (one or the other).

As shown in FIG. 15B, the weight of the job fit, the culture fit and the context filter are converted into multiplication factors for each of the competency raw score.

The adjusted score 422 for each competency can therefore be sorted, by decreasing order, to rank each competency from the most valuable to the less valuable.

### Virtual Coach

### Recommendations and Actions Items

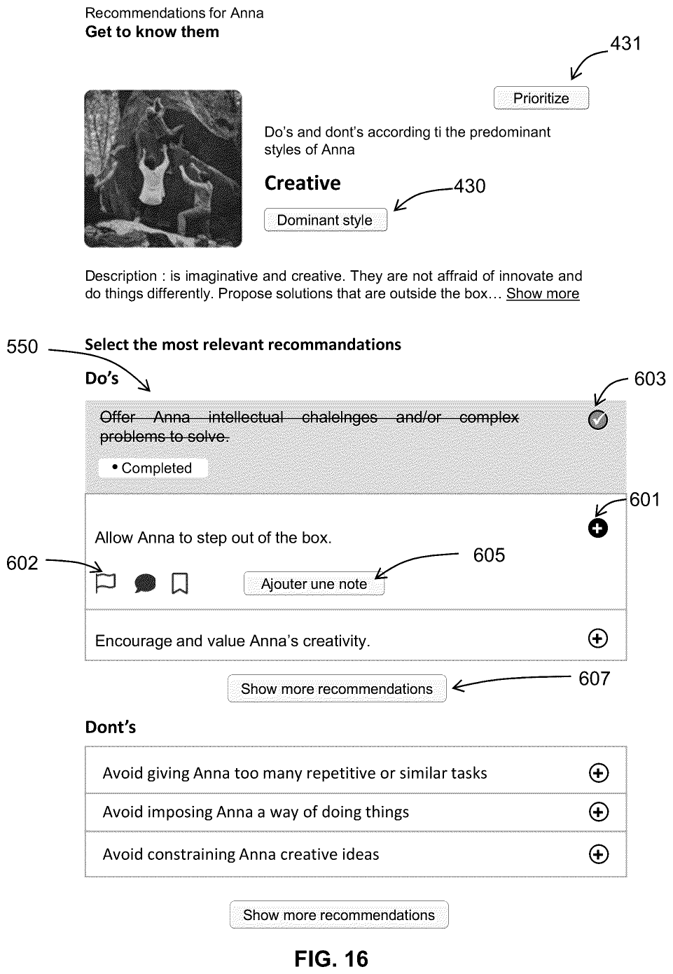

FIGS. 16 to 22 shows exemplary displays of the virtual coach on the user interface of the manager.

FIG. 16 is an exemplary display of the dominant style of the resource, with actions items 550 directed to the manager, according to the dominant style 430 as previously identified. A priority tag 431 can also be displayed. The action items 550 are retrieved from an expert sub-dataset 210 stored in the data storage 65. The AI recommender system 70 can propose the most relevant set of “Do and Don'ts” for a specific dominant style of the resource, taking in consideration the dominant style of the manager.

The user interface 60 of the virtual coach platform can also provide means for the manager to provide feedback or field data 600 on the output generated by the AI recommender system 70, such as selection of the most relevant actions items 601, selection of priority tag 602. The actions items can also be sorted by the manager by drag and drop. The manager can also select the actions items that are completed 603. The manager can also add some personal notes 605 to enrich the recommendation. The manager also has the option to show more recommendations 607.

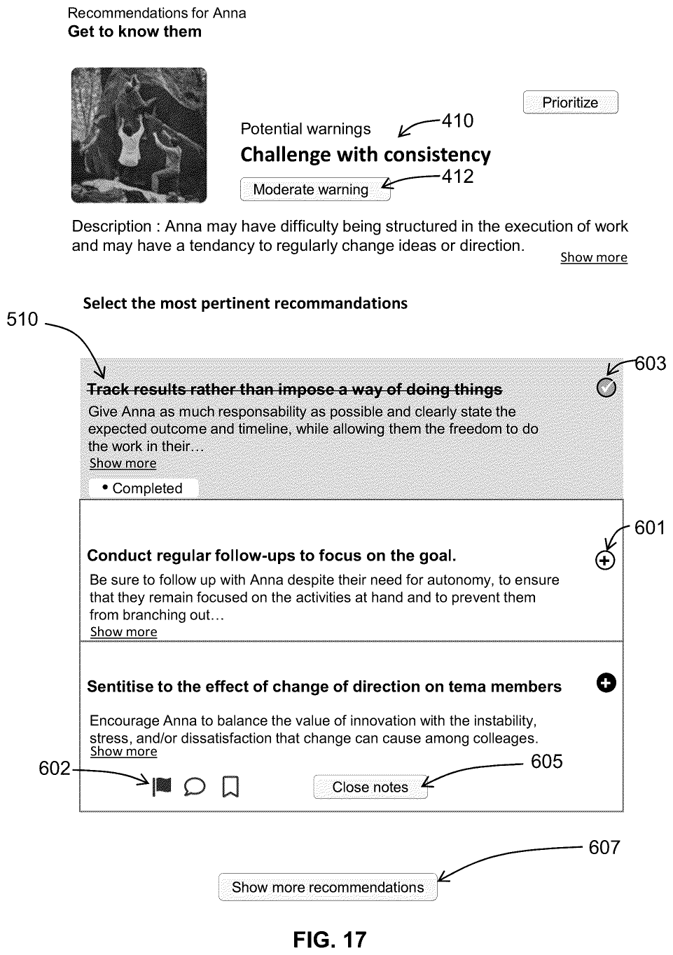

Referring to FIGS. 17, the display of recommendations 510 directed to the manager can also indicates some warnings or alerts 410 according to the strengths or challenges of the duo as previously identified. The intensity of the warning 412 is also displayed. The user interface 60 of the virtual coach platform can also provide means for the manager to provide feedback or field data 600 on the output generated by the AI recommender system 70, such as selection of the most relevant actions items 601, selection of priority tag 602, actions items that are completed 603, personal notes 605 and option to show more recommendations 607, as described above.

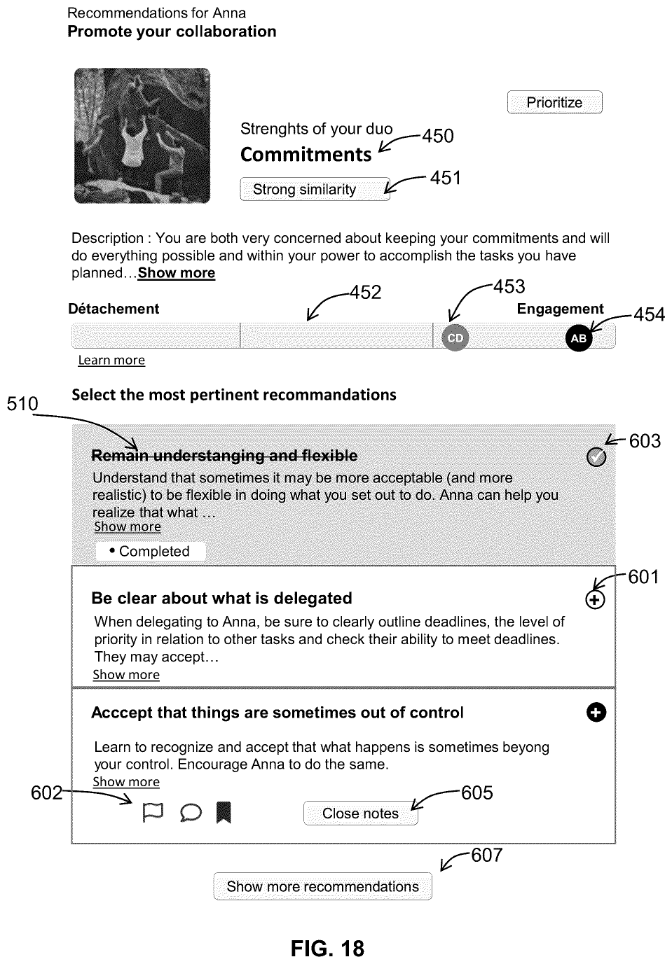

Referring to FIGS. 18, the display of recommendations 510 directed to the manager can also indicates the strengths of the duo 450 as previously identified. The intensity of the strength 451 is also displayed. The results can be displayed on a bipolar scale 452, with a first indicator of position 453 for the manager and a second indicator of position 454 for the resource.

The user interface 60 of the virtual coach platform can also provide means for the manager to provide feedback or field data 600 on the output generated by the AI recommender system 70, such as selection of the most relevant actions items 601, selection of priority tag 602, actions items that are completed 603, personal notes 605 and option to show more recommendations 607, as described above.

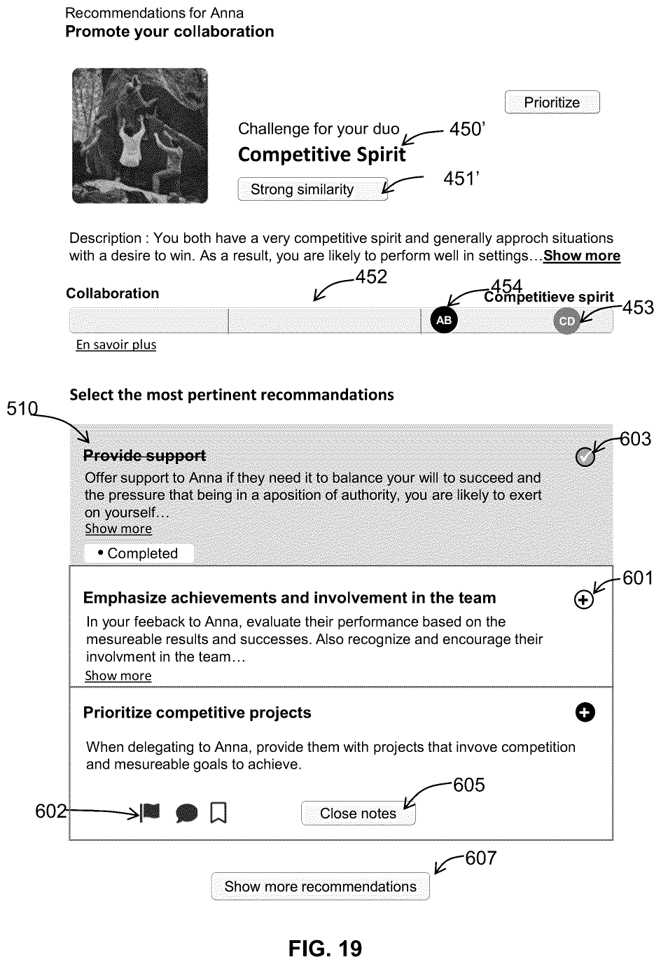

Referring to FIGS. 19, the display of recommendations 510 directed to the manager can also indicates the challenges of the duo 450′ as previously identified. The intensity of the challenge 451′ is also displayed. The results can be displayed on a bipolar scale 452, with a first indicator of position 453 for the manager and a second indicator of position 454 for the resource.

The user interface 60 of the virtual coach platform can also provide means for the manager to provide feedback or field data 600 on the output generated by the AI recommender system 70, such as selection of the most relevant actions items 601, selection of priority tag 602, actions items that are completed 603, personal notes 605 and option to show more recommendations 607, as described above.

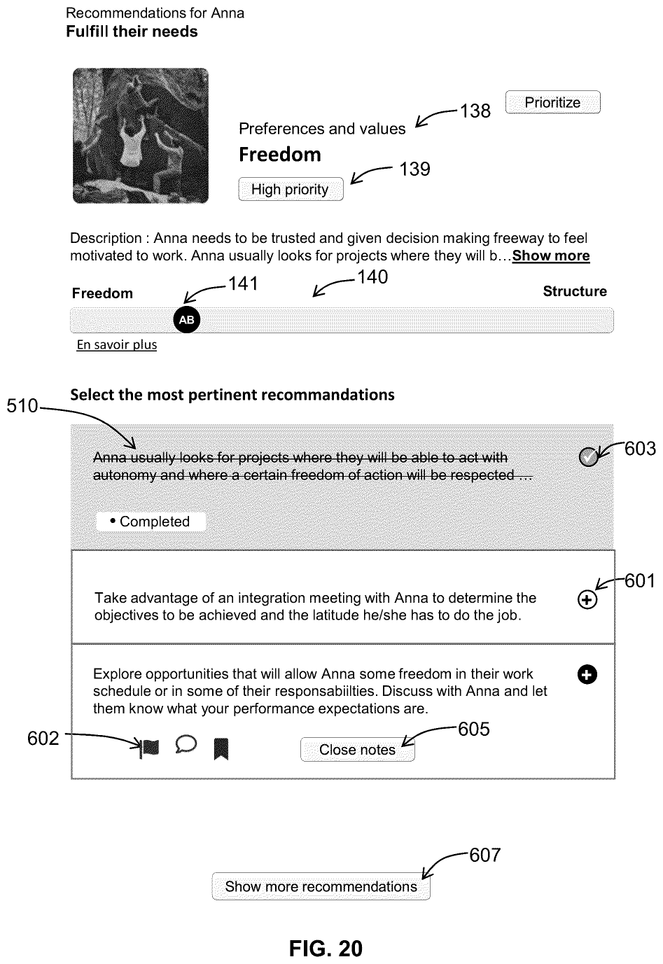

Referring to FIGS. 20, the display of recommendations 510 directed to the manager can also indicates the preferences and values 138 of the resource as previously identified. The intensity of the value 139 is also displayed. The results can be displayed on a bipolar scale 140, with an indicator of position 141 of the resource.

The user interface 60 of the virtual coach platform can also provide means for the manager to provide feedback or field data 600 on the output generated by the AI recommender system 70, such as selection of the most relevant actions items 601, selection of priority tag 602, actions items that are completed 603, personal notes 605 and option to show more recommendations 607, as described above.

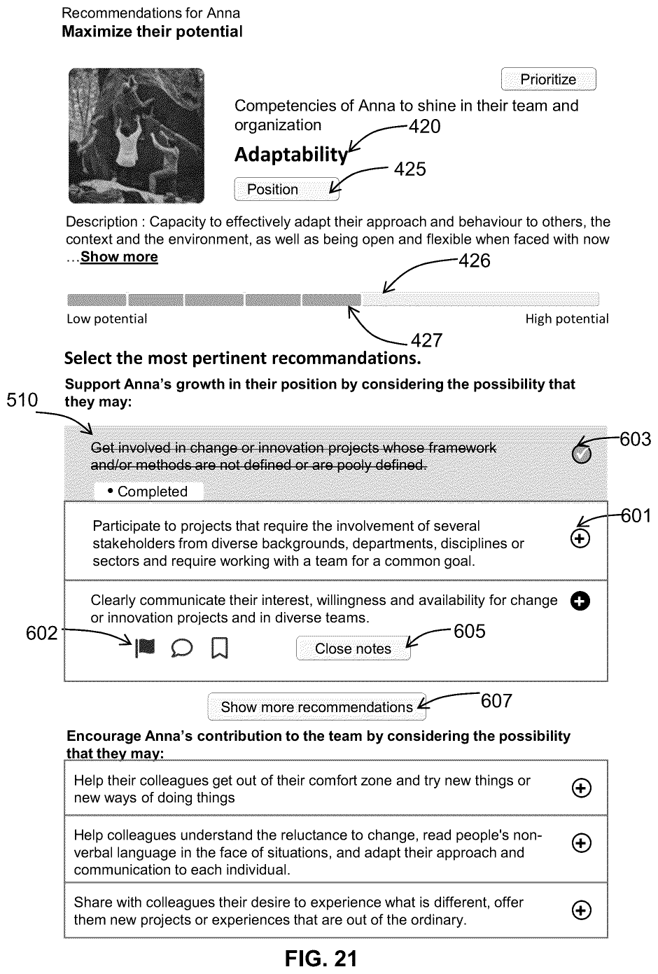

Referring to FIG. 21, the display of recommendations 510 directed to the manager can also indicates the competencies 420 of the resource as previously identified. The dimension 425 towards which this competency is directed is also displayed, such as “Position”, “context”, or “organizational culture”. The results can be displayed on a bipolar scale 426, with an indicator of position 427 of the resource, from “low potential” to “high potential”.

The user interface 60 of the virtual coach platform can also provide means for the manager to provide feedback or field data 600 on the output generated by the AI recommender system 70, such as selection of the most relevant actions items 601, selection of priority tag 602, actions items that are completed 603, personal notes 605 and option to show more recommendations 607, as described above.

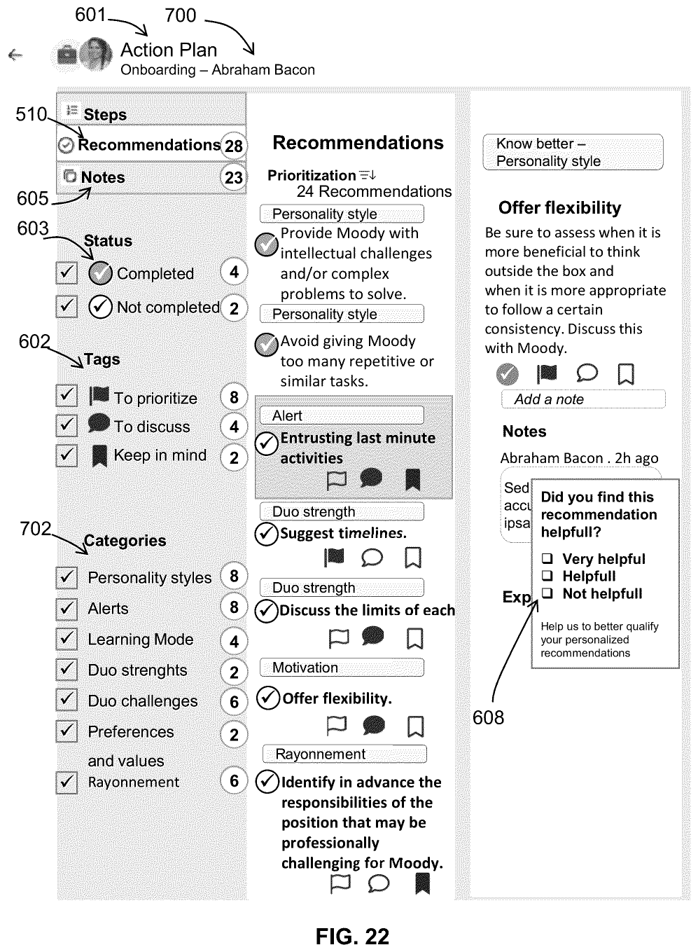

Referring to FIG. 22, there is shown a synthesis display (or dashboard) 700 accessible for the manager for the plan of the action items 601 (action plan). On the left side, a menu column displays all accessible pages for the manager, including but not limited to different steps of the process, recommendations 510, personal notes 605, status of actions items that are completed 603, list of tags 602 such as “to prioritize”, “to discuss”, or “to keep in mind”, and a filter by categories 702 (“personality styles”, “alerts”, “learning mode”, “duo strengths”, “duo challenges”, “preferences and values” and “shining”).

The user interface 60 of the virtual coach platform can also provide means for the manager to provide feedback or field data 600 on the output generated by the AI recommender system 70, such as a usefulness or helpfulness assessment 608.

The examples shown in FIGS. 16 to 22 are examples of recommendations and action items directed to the manager, but similarly, recommendations and action items directed to the resource can also be displayed by the user interface 60 of the virtual coach platform. The user interface 60 of the virtual coach platform can also provide means for the resource to provide feedback or field data 600 on the output generated by the AI recommender system 70, such as selection of the most relevant recommendations 601′, or selection of priority tag 602′.

### AI and Machine Learning Model

According to another embodiment, the AI-recommender system 70 can comprise one or more machine learning models. Different machine learning models can be used to determine or predict the outputs described above, such as competencies, strengths/challenges of a pair of individuals, recommendations and alerts. The technical challenge with using machine learning models reside in training the machine learning models, as there is initially insufficient training data available to properly train the machine learning models. Machine learning models requires large training dataset that have been properly labelled.

Another technical challenge is to complement static business rules with field data 600 and to propose decision based on both synthetic dataset 200 and field dataset 300 inputs.

The expression “field dataset” 300 is meant to refer to field data collected from real-life psychometric experiments and studies, as for example feedback provided by users of the virtual coach.

In a typical machine learning model application, a training dataset is labelled according to one or more desired outputs. The training dataset is fed to the machine learning model. After the initial training, as more data become available, models can be successively retrained to progressively adapt their predictions (for example by changing weights assigned to layers of nodes in the model) based on evolution of the desired outputs. In the present case, the initially available field dataset 300 is not available to properly train machine learning models. The Applicant has overcome this challenge by relying on a training dataset built entirely from synthetic data (synthetic dataset 200) when initially training the machine learning model(s). In the present application, the synthetic dataset 200 is computer-generated data that embeds the static business rules. It has been generated, using a simulator solely based on the deterministic rules described previously. Synthetic data differs from “augmented data” in that it is entirely “artificial”, and it not derived from real/field data.

In one possible implement, the process requires generating a synthetic dataset 200 based on a plurality of artificially created individuals, artificially created job profiles and artificially created organizational contexts. The artificially generated individuals, jobs and organizations entries are each defined by a set of randomly assigned attributes. Using the deterministic version of the AI-recommender system 70, competencies rankings can be generated for a given individual. Randomly generated pairs or duos are also generated and characteristics corresponding to strengths of the duo can also be ranked. Similarly, randomly generated resources (individuals) and job profiles can be assigned an adjusted score using the deterministic version of the AI-recommender system 70. An entirely synthetic dataset 200 can be created as described above, where a collection of attribute entries, job entries, organization entries are labelled with duo and job scores, after having been processed through the deterministic AI-recommender system 70.

Millions of simulations can be generated to create the synthetic dataset 200. Once the synthetic dataset is generated, one or more machine learning models can be initially trained, using only the synthetic dataset 200. The machine learning model can be selected from existing predictive models, including ensemble models, boosting models, support vector machines, naïve Bayes models and/or neural networks.

By training the machine learning models using the synthetic dataset 200, the machine learning models will “learn” the static business rules encoded in this dataset without being explicitly provided with these rules. Once trained, the machine learning model-based AI-recommender system can be used to predict competencies of resources and manager duos, as well as strengths and challenges of the duos. Recommendations and actions items will also be generated using the machine learning model-based AI-recommender system.

Through use, a field dataset 300 will gradually be created. The field dataset will be composed of the same columns as the synthetic dataset in such a way that both datasets can be combined. The machine learning model-based AI-recommender system will thus be periodically retrained, using a mix of field dataset 300 and the synthetic dataset 200. The proposed application also allows a very smooth transition of model outcomes as field data gradually augments the synthetic data. In order to avoid biasing the predictions of the machine learning model-based AI-recommender system, the mix or ratio of field dataset 300 versus synthetic dataset 200 can be controlled or adjusted. By ensuring that mix of field and synthetic data is used to periodically retrain the machine learning models, human bias that are inherently present in psychometric data can be mitigated, since the models always adjust or reconfigure their settings using synthetic data as a subset of the training dataset.

In an embodiment, the user interface 60 of the virtual coach platform will provide means for users to provide feedback or field data 600 on the output generated by the machine learning model-based AI-recommender system. For example, the one or more machine learning models of AI recommender system, having been trained entirely on synthetic data, may output competencies, alerts and recommendations that end users (such as team managers and/or HR manager) will not entirely agree with. The graphical user interface of the virtual coach platform can thus include means for the manager to provide feedback on the predictions and/or recommendations, such as boxes to checks, priority tag, usefulness/relevancy of suggestions, comments that can be entered, etc. The graphical user interface of the virtual coach platform can also include means for the resource to provide feedback, such as satisfaction following onboarding process, satisfaction on the current job, psychological well being, psychological distress, reason for departure. The inputs captured through the graphical user interface of the virtual coach platform can be used as a retroaction to adjust the predictions of the machine learning models.

The process thus allows receiving, from the user interface 60, a selection of a subset of the recommendations and actions items that have been generated by the machine learning model-based AI-recommender system, based on the predicted competencies, strengths and challenges of duos and/or fit score of individuals with job profiles. Virtual coach analyses can be performed and repeated for a plurality of organizations and for a plurality of duos of resources and managers, which will create and update field dataset based on an association of the inputted entries with the generated strengths and challenges, and with the subsets of recommendations and actions items selected for each duo. The AI recommender system can then be iteratively modified using the field dataset that is gradually built through repeated use of the AI recommender system, to reflect the selections (feedback) provided through the user interface.

The system and method described above is mainly applicable within an organization where a manager manages resources such as team members, but it is understood that this method could be applicable in any hierarchical relationship, such as a parent with his/her child, a teacher with his/her student, or any other hierarchical relationship.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A computer-implemented method for assessing compatibility of resources within organizations, the method comprising:
retrieving, from a profile dataset, attribute entries associated with a given resource and a manager, job entries associated with one or more job profiles, and organization entries associated with the organization;
inputting in an AI recommender system the attribute entries, the job entries and the organization entries,
generating by the AI recommender system:
competencies scores of the given resource and the manager;
an indication of strengths and challenges of a duo formed by the given resource and the manager, for a given job profile within the organization; and
recommendations and action items based on the indication of the strengths and challenges of the duo; and
displaying, in a user interface, the competencies scores of the given resource and the manager, the strengths and the challenges of the duo and the recommendations and actions items for the duo.

2. The computer-implemented method of claim 1, further comprising the steps of:
generating by the AI recommender system:
adjusted competencies scores of the given resource based on the given job profile within the organization and based on a context and company culture; and
recommendations and action items based on the adjusted competencies scores; and
displaying, in the user interface, the strengths and the challenges of the resource based on the adjusted competencies scores and the recommendations and actions items for the resource based on the given job profile and the given context and company culture.

3. The computer-implemented method of claim 1, wherein the AI recommender system is configured based on static rules derived from scientific studies.

4. The computer-implemented method of claim 1, wherein the AI recommender system comprises one or more machine learning models.

5. The computer-implemented method of claim 4, wherein the method further comprises the step of:
training the one or more machine learning models using a combination of a synthetic dataset and a field dataset;
the attribute entries, the job profile entries and the organization entries being inputted in the trained machine learning models, and
the trained machine learning models predicting: the competencies of the resource, the competencies of the manager, the indication of the strengths and challenges of any given duo of resource-manager and the recommendations and action items for said given duo.

6. The computer-implemented method of claim 5, wherein the method further comprises the step of:
generating the synthetic dataset based on a plurality of artificially created duos of individuals linked to random job profiles and random organizations, the artificially created duos being defined by specific attributes parameters and being attributed specific competencies, specific strengths and challenges and specific recommendations and actions items obtained from deterministic rules.

7. The computer-implemented method of claim 5, wherein the one or more machine learning models are initially trained using only the synthetic dataset.

8. The computer-implemented method of claim 5, the method further comprising:
receiving, from the user interface, a selection of a subset of the recommendations and actions items; and
repeating the previous steps for a plurality of organizations and for a plurality of duos of resources and managers, to create and update a field dataset based on an association of the inputted entries with the generated strengths and challenges, and with the subsets of recommendations and actions items selected for each duo; and
iteratively modifying the AI recommender system using the field dataset that is gradually built through repeated use of the AI recommender system, to reflect the selections made in the user interface.

9. The computer-implemented method of claim 5, wherein a ratio of the field dataset over the synthetic dataset is adjustable.

10. The computer-implemented method of claim 5, wherein an assessment of relevancy of the recommendations and action items is also captured from the user interface, the assessment being used in generating and/or updating the field dataset.

11. The computer-implemented method of claim 5, wherein the recommendations and actions items for the duo, displayed in the user interface comprises:
recommendations directed to the resource;
recommendations directed to the manager;
action items directed to the resource; and/or
action items directed to the manager.

12. The computer-implemented method of claim 11, wherein a portion of the recommendations and actions items for the duo, displayed in the user interface comprises a priority tag.

13. The computer-implemented method of claim 8, wherein the selection comprises at least one of a prioritization, a selection, a completeness check of the recommendations and/or of the action items.

14. The computer-implemented method of claim 1, wherein attributes entries associated with a given resource comprises parameters obtained from at least one of: a psychometric evaluation, a cognitive ability test, a personality test, an organizational preferences test; and a learning mode test.

15. The computer-implemented method of claim 1, wherein attributes entries associated with a manager comprises parameters obtained from at least one of: a psychometric evaluation, a personality test, and a learning mode test.

16. The computer-implemented method of claim 1, wherein predicting the indication of the strengths and challenges of the duo further comprises predicting:
a dominant personality style and a secondary personality style of the resource and the manager; and
preferences and values for the resource.

17. The computer-implemented method of claim 1, wherein the AI recommender system is accessible by at least one application programming interface (API).

18. A system implementing a virtual coach platform for assessing compatibility of resources within an organization, the system comprising:
one or more processors;
a user interface that obtains attributes entries associated with a given resource and a manager, job entries associated with one or more job profiles, and organization entries associated with the organization; wherein the attribute entries, the job entries, and the organization entries are stored in a profile dataset;
a memory storing instructions that, when executed by the one or more processors, cause the system to perform operations comprising:
retrieving, from a given profile dataset of the memory, attributes entries associated with a given resource and a manager, job entries associated with one or more job profiles, and organization entries associated with the organization;
inputting in an AI recommender system the attributes entries, the job profile entries and the organization entries,
generating by the AI recommender system:
competencies scores of the given resource and the manager;
an indication of strengths and challenges of a duo formed by the given resource and the manager, for a given job profile within the organization; and
recommendations and action items based on the indication of the strengths and challenges of the duo; and
displaying, in a user interface, the competencies scores of the given resource and the manager, the strengths and the challenges of the duo and the recommendations and actions items for the duo.

19. A non-transitory computer-readable storage medium storing instructions that, when executed by a computing system having one or more processors, cause the computing system to perform operations for assessing compatibility of resources within an organization, the operations comprising:
retrieving, from a given profile dataset, attributes entries associated with a given resource and a manager, job entries associated with one or more job profiles, and organization entries associated with the organization;
inputting in an AI recommender system the attributes entries, the job profile entries and the organization entries,
generating by the AI recommender system:
competencies scores of the given resource and the manager;
an indication of strengths and challenges of a duo formed by the given resource and the manager, for a given job profile within the organization; and
recommendations and action items based on the indication of the strengths and challenges of the duo; and
displaying, in a user interface, the competencies scores of the given resource and the manager, the strengths and the challenges of the duo and the recommendations and actions items for the duo.
